(19) United States
(12) Patent Application Publication
(10) Pub. No.: US 2014/0048974 A1
(43) Pub. Date: Feb. 20, 2014

(54) Method Of Making A Golf Ball

(71) Applicant: NIKE, Inc., Beaverton, OR (US)

(72) Inventors: Arthur Molinari, Portland, OR (US); Chien-Hsin Chou, Yun-lin Hsien (TW); Chen-Tai Liu, Yun-lin Hsien (TW)

(73) Assignee: NIKE, Inc., Beaverton, OR (US)

(21) Appl. No.: 13/964,597

(22) Filed: Aug. 12, 2013

Related U.S. Application Data
(60) Provisional application No. 61/682,733, filed on Aug. 13, 2012.

(51) Int. Cl. B29D 99/00

(52) U.S. Cl. CPC B29D 99/0042
USPC 264/255

(57) ABSTRACT

A method of making a golf ball is disclosed. The golf ball includes a resin inner core, a rubber outer core, and a cover. The resin inner core is made of a highly neutralized polymer and at least one ionomer. The cover is a dimpled ionomer cover, made of a blend of different grades of ionomer. This construction provides desirable compression, coefficient of restitution, and moment of inertia properties. The ball as a whole has properties to maximize performance and aesthetic properties, such as driver distance, iron control, feel, and sound. The ball is particularly well-suited to balancing driver initial velocity and compression so that driver trajectory and distance is maintained or improved while greater control and feel is enhanced.

### CROSS-REFERENCE TO RELATED APPLICATION

This application claims priority under 35 U.S.C. §119(e) to U.S. Provisional Patent Application No. 61/682,733, entitled “Method of Making a Golf Ball”, and filed on Aug. 13, 2012, which application is hereby incorporated by reference.

### BACKGROUND

The game of golf is an increasingly popular sport at both amateur and professional levels. A wide range of technologies related to the manufacture and design of golf balls are known in the art. Such technologies have resulted in golf balls with a variety of play characteristics and durability. For example, some golf balls have a better flight performance than other golf balls. Some golf balls with a good flight performance do not have a good feel when hit with a golf club. Some golf balls with good performance and feel lack durability. Thus, it would be advantageous to make a conforming and durable golf ball with a good flight performance that also has a good feel.

### SUMMARY

A method of making a golf ball is disclosed. The golf ball includes a resin inner core, a rubber outer core, and a cover. The resin inner core is made of a highly neutralized polymer and at least one ionomer. The cover is a dimpled ionomer cover, made of a blend of different grades of ionomer. This construction provides desirable compression, coefficient of restitution, and moment of inertia properties. The ball as a whole has properties to maximize performance and aesthetic properties, such as driver distance, iron control, feel, and sound. The ball is particularly well-suited to balancing driver initial velocity and compression so that driver trajectory and distance is maintained or improved while greater control and feel is enhanced.

In one aspect, a method of manufacturing a golf ball is disclosed. The method may include blending a highly neutralized acid polymer with a first ionomer to form a resin blend. The highly neutralized acid polymer may have a first flexural modulus of less than 8,000 psi, and the first ionomer having a second flexural modulus of less than 8,000 psi. The method may further include injection molding the resin blend to form an inner core of the golf ball. The method may include compression molding a thermoset material around the inner core to form an outer core surrounding the inner core. The method may include injection molding a cover layer around the outer core.

In another aspect, a method of manufacturing a golf ball is disclosed. The method may include blending a highly neutralized acid polymer with a first ionomer to form a resin blend. The highly neutralized acid polymer may have a first flexural modulus of less than 8,000 psi, and the first ionomer may have a second flexural modulus of less than 8,000 psi. The first ionomer may include from about 1 to about 20 parts by weight of the inner core, based on 100 parts by weight of the inner core. The method may further include injection molding the resin blend to form an inner core of the golf ball. The method may include providing a first mold plate including a first mold surface. The method may include providing a second mold plate including a second mold surface corresponding to the first mold surface. The method may include positioning a material between the first mold surface and the second mold surface. The method may further include moving at least one of the first mold plate and the second mold plate towards the other of the first mold plate and the second mold plate thereby compressing the material into a first hemispherical cup.

In another aspect, a method of manufacturing a golf ball is disclosed. The method may include blending a highly neutralized acid polymer with a first ionomer to form a resin blend. The highly neutralized acid polymer may have a first Vicat softening temperature and the first ionomer has a second Vicat softening temperature. The absolute value of difference between the first Vicat softening temperature and the second Vicat softening temperature may not be greater than 10 degrees Celsius. The method may further include injection molding the resin blend to form an inner core of the golf ball. The method may include compression molding a thermoset material around the inner core to form an outer core surrounding the inner core. The method may include injection molding a cover layer around the outer core.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows a first representative golf ball in accordance with this disclosure, the golf ball being of a two-piece construction.

FIG. 2 shows a second representative golf ball, the golf ball having an inner cover layer and an outer cover layer.

FIG. 3 shows a third representative golf ball, the golf ball having an inner core and an outer core.

FIG. 4 shows a fourth representative golf ball, the golf ball having an inner core, an outer core, an inner cover layer, and an outer cover layer.

FIG. 5A is a side cross-sectional view of a conventional mold for molding an outer core half, the mold shown in an initial, open position.

FIG. 5B is a side cross-sectional view of a conventional mold for molding an outer core half after a slug has been introduced, the mold shown in an open position with the mold material positioned within the mold.

FIG. 5C is a side cross-sectional view of a conventional mold for molding an outer core half with the mold in a closed position.

FIG. 5D is a side cross-sectional view of an embodiment of a core with an inner core and two outer core halves.

FIG. 5E is a side cross-sectional view of an embodiment of a mold to mold outer core halves and an inner core together.

FIG. 6A is a side cross-sectional view of an embodiment of a conventional mold for molding an outer core half, the mold shown in an initial, open position.

FIG. 6B is a side cross-sectional view of a conventional mold for molding an outer core half after a slug has been introduced, the mold shown in an open position with the mold material positioned within the mold.

FIG. 6C is a side cross-sectional view of a conventional mold for molding an outer core half with the mold in a closed position.

### DETAILED DESCRIPTION

Generally, the present disclosure relates to a method of making a golf ball with a resin inner core and a rubber outer core. While many advantageous performance and feel properties may be found in a golf ball with a resin inner core and a rubber outer core, it is believed by the inventors that the design disclosed herein allows these advantageous performance and feel properties to be more fully realized.

As used herein, the term “about” is intended to allow for engineering and manufacturing tolerances, which may vary depending upon the type of material and manufacturing process, but which are generally understood by those in the art. For example, “about” generally corresponds to +/−2 units, regardless of scale, when measuring hardness; +/−0.15 mm when measuring compression when the initial load is 10 kg and the final load is 130 kg; and +/−0.005 when measuring specific gravity. Also, as used herein, unless otherwise stated, compression, hardness, COR, durability, and flexural modulus are measured as follows:

Compression deformation: The compression deformation herein indicates the deformation amount of the ball under a force; specifically, when the force is increased to become 130 kg from 10 kg, the deformation amount of the ball under the force of 130 kg subtracts the deformation amount of the ball under the force of 10 kg to become the compression deformation value of the ball. All of the tests herein are performed using a compression testing machine available from Automated Design Corp. in Illinois, USA or EKTRON TEK Co., LTD.; Model name: EKTRON-2000 GBMD-CS. Both compression tester machines can be set to apply a first load and obtain a first deformation amount, and then, after a selected period, apply a second, typically higher load and determine a second deformation amount. Thus, the first load herein is 10 kg, the second load herein is 130 kg, and the compression deformation is the difference between the second deformation and the first deformation. Herein, this distance is reported in millimeters. The compression can be reported as a distance, or as an equivalent to other deformation measurement techniques, such as Atti compression.

Hardness: Hardness of golf ball layer is measured generally in accordance with ASTM D-2240, but measured on the land area of a curved surface of a molded ball. Other types of hardness, such as Shore C or JIS-C hardnesses may be provided as specified herein. For material hardness, such as those materials intended to be used in a golf ball, but not yet manufactured into a golf ball, the hardness is measured in accordance with ASTM D-2240 (on a plaque).

Method of measuring COR: A golf ball for test is fired by an air cannon at an initial velocity of 131 ft/s, or another selected velocity, but if not otherwise specified, 131 ft/s is the initial velocity for COR tests and values discussed herein. The test golf ball is fired at a steel plate positioned about 1.2 meters away from the air cannon. A speed monitoring device is located over a distance of 0.6 to 0.9 meters from the cannon. After striking the steel plate, the golf ball rebounds through the speed-monitoring device. The return velocity divided by the initial velocity is the COR. A COR measuring system is available from ADC.

Durability: Durability is generally measured by following the protocol for measuring COR, as described above, for 150 shots or until the golf ball fails. When the golf ball fails, the COR noticeably and suddenly drops.

Flexural Modulus: The material is measured generally in accordance with ASTM D790, which measures the deflection in a beam of the material in a three point bending system.

Any ball described herein is considered conforming if the ball adheres to the Rules of Golf established by the United States Golf Association (USGA). All other balls are considered non-conforming.

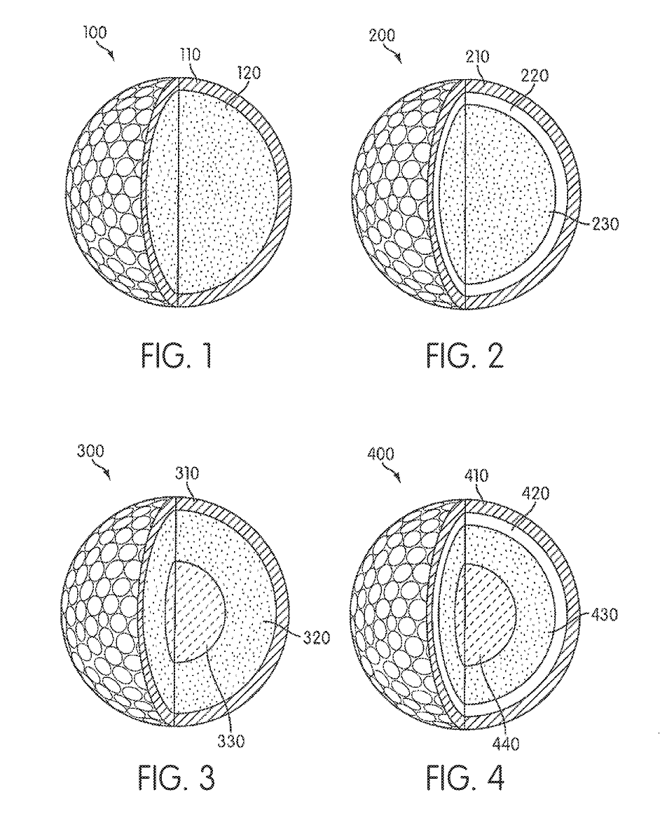

FIGS. 1-4 show various embodiments of multi-piece golf balls in accordance with this disclosure. FIG. 1 illustrates the outer surface of cover layer 110 as having a generic dimple pattern. While the dimple pattern on golf ball 100 may affect the flight path of golf ball 100, any suitable dimple pattern may be used with the disclosed embodiments. In some embodiments, golf ball 100 may be provided with a dimple pattern including a total number of dimples between approximately 250 and 450.

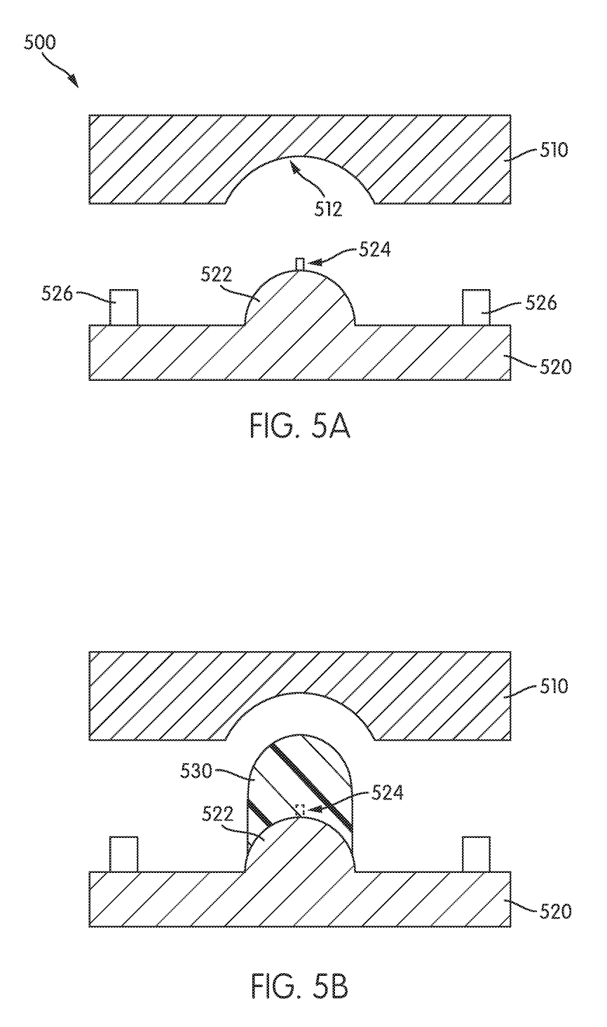

FIG. 2 shows a second golf ball 200 having aspects in accordance with this disclosure. Golf ball 200 includes a core 230, a mantle layer 220 substantially surrounding core 230, and an outer cover layer 210 substantially surrounding mantle 220.

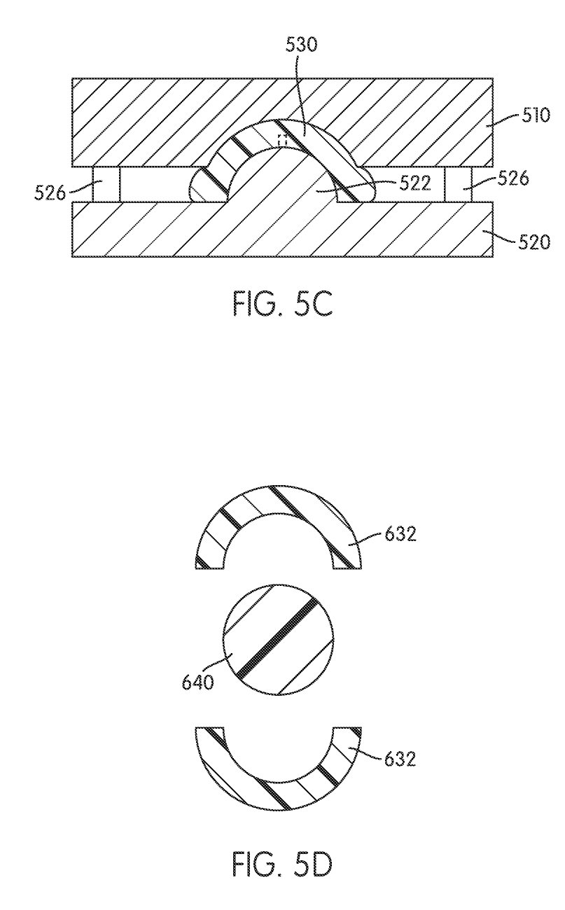

FIG. 3 shows a third golf ball 300 having aspects in accordance with this disclosure, where third golf ball 300 has a three-piece construction. Three-piece golf ball 300 includes a first inner core 330, a first outer core 320 substantially surrounding first inner core 330, and a first cover layer 310 substantially surrounding first outer core 320.

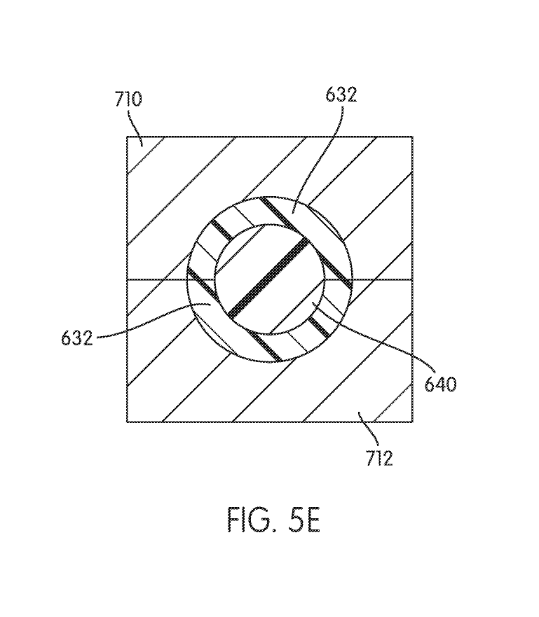

FIG. 4 shows a fourth golf ball 400 having aspects in accordance with this disclosure, where fourth golf ball 400 has a four-piece construction. Golf ball 400 includes a second inner core 440, a second outer core 430 substantially surrounding second inner core 440, an inner cover layer 420 substantially surrounding outer core 430, and an outer cover layer 410 substantially surrounding inner cover layer 420.

Generally, the term “core” as used herein refers to at least one of the innermost structural components of the golf ball. The term core may therefore refer, with reference to FIG. 3 but applicable to any embodiment discussed herein, to (1) first inner core 330 only, (2) both first inner core 330 and first outer core 320 collectively, or (3) first outer core 320 only. The term core may also encompass more than two layers if, for example, an additional structural layer is present between first inner core 330 and first outer core 320 or encompassing first outer core 320.

As shown in FIG. 3, golf ball 300 includes an inner core 330, an outer core 320, and a cover layer 310. Inner core 330 is generally made from a resin, such as a thermoplastic polymer. Outer core 320 is generally made from rubber. Cover layer 310 is generally made from a resin material, such as a thermoplastic polymer. Outer cover layer 310 includes dimples. Cover layer 310 is coated by a single top coat or includes two layers of coating, where one layer is a primer layer adjacent outer cover layer 310 and the other layer is a top coat positioned on the primer layer. The inventors have found that an exemplary embodiment of this three-piece design, discussed herein in greater detail and referred to as either the first exemplary embodiment or Design 1, has performance properties that may prove particularly advantageous to amateur golfers whose focus is on improving flight distance. While the exemplary embodiment has good flight performance and initial velocity off the driver, the exemplary embodiment also has a soft feel, satisfactory spinnability and control on iron and wedge shots along with good durability. The inventors have found another exemplary embodiment of this three-piece design, discussed herein in greater detail and referred to as either the second exemplary embodiment of Design 2, has performance properties that may prove particularly advantageous to amateur golfers whose focus is on improving flight distance, but who prefer a slightly harder feel and increased spinnability over the first exemplary embodiment.

Inner core 330 is made from a highly neutralized polymer composition, sometimes called a highly neutralized acid polymer or highly neutralized acid polymer composition, and at least one additional component, such as a filler. Highly neutralized polymer compositions may be considered to be at least 80 percent neutralized, though many highly neutralized polymer compositions are neutralized to greater than 90 percent, greater than 95 percent, or are even substantially completely neutralized. Inner core 330 generally includes a first highly neutralized polymer and a second highly neutralized polymer. Inner core 330 generally includes HPF resins such as HPF2000 and HPF AD1035, produced by and available from E. I. DuPont de Nemours and Company, though any highly neutralized polymer that has the properties specified herein, particularly hardness, would be appropriate.

The flexural modulus of the highly neutralized polymer in some embodiments is less than about 8,000 psi. In some embodiments, the highly neutralized polymer is about 95 parts by weight of the total composition of the core. In some embodiments, the highly neutralized polymer is about 80 parts by weight of the total composition of the core. In some embodiments, such as the exemplary embodiments, the highly neutralized polymer is HPF AD1035, which has a flexural modulus between 6,300 and 7,300 psi. The highly neutralized polymer of inner core has a first Vicat softening temperature between 45 degrees C. and 65 degrees C. For example, HPF AD1035 has a Vicat softening temperature of about 54 degrees C.

Inner core 330 also includes a second component, a first ionomer. In some embodiments, such as the first exemplary embodiment, the ionomer is used as a carrier for another component, such as color. In these embodiments, the amount of ionomer is between 1 and 20 parts by weight, based on 100 parts of weight of inner core 330. In some embodiments, the amount of first ionomer is relatively low, such as between 1 and 10 parts by weight, based on 100 parts of weight of inner core 330. In the exemplary embodiment, the first ionomer is about 5 parts by weight of inner core 330, based on 100 parts of weight of inner core 330.

Inner core 330 may also include a third component, a second ionomer. In some embodiments, the second ionomer is used to increase the hardness of inner core 330 and flexural modulus of inner core 330. In some embodiments, such as the second exemplary embodiment which has a harder cover layer than the first exemplary embodiment, as discussed below, the ionomer may be used to balance the ball so that the ball has good initial velocity off the driver while remaining a conforming ball with good feel. In these embodiments, the ionomer may be about 10 to about 30 parts by weight of inner core 330, based on 100 parts of weight of inner core 330. In other embodiments, the second ionomer may be between 0 and 25 parts by weight of inner core 330, based on 100 parts of weight of inner core 330. In the second exemplary embodiment, the ionomer is about 15 percent by weight of inner core 330. Because the first exemplary embodiment contains only the first ionomer, the first exemplary embodiment could be considered to have 0 parts by weight of the second ionomer.

It is intended in some embodiments that the first ionomer is a different ionomer or grade of ionomer than the second ionomer. For example, in some embodiments, the first ionomer may be Surlyn® 6320 and the second ionomer may be Surlyn® 8940. The first ionomer has a flexural modulus of less than about 8,000 psi. For example, the first ionomer may have a flexural modulus between 4,000 psi and 8,000 psi. In some embodiment, the first ionomer has a flexural modulus of about 4,300 psi. In some embodiments, the first ionomer has a flexural modulus of about 7,700 psi. The second ionomer has a flexural modulus of greater than about 10,000 psi. In some embodiments, the second ionomer has a flexural modulus of about 50,800 psi. In some embodiments, the sum of the flexural modulus of the highly neutralized polymer and the flexural modulus of the first ionomer is less than the flexural modulus of the second ionomer.

In any of the embodiments, the first ionomer and/or the second ionomer may be Surlyn®, available from E.I. DuPont de Nemours and Company. In some embodiments, the first ionomer and the second ionomer is Surlyn® 9320, Surlyn® 9320W, or Surlyn® 6320, all available from E.I. DuPont de Nemours and Company. In some embodiments, the second ionomer is Surlyn® 8940. In other embodiments, the first ionomer and the second ionomer may be another type or brand name of ionomer. The ionomer, whether used for the first ionomer or the second ionomer, has a Vicat softening temperature such that the absolute value of the difference between the Vicat softening temperature of the ionomer and the highly neutralized polymer is not greater than about 10 degrees C.

By adding the ionomer or ionomers to the resin inner core, the flexibility of ball design is increased. For example, a designer is more able to fine tune COR, flexural modulus, hardness, specific gravity, spin, speed, launch angle, and impact sound by including the low flexural modulus ionomer. Further the manufacturing facility can account more readily for inconsistencies in any single material when incorporating the low flexural modulus ionomer. In particular, adding the second ionomer when the cover hardness is greater than about 68 Shore D helps to balance the feel of the ball, since inner core is relatively soft, as is discussed further below.

Inner core 330 may also include additives, fillers, and flow modifiers. Suitable additives and fillers may include, for example, blowing and foaming agents, optical brighteners, coloring agents, fluorescent agents, whitening agents, UV absorbers, light stabilizers, defoaming agents, processing aids, mica, talc, nanofillers, antioxidants, stabilizers, softening agents, fragrance components, plasticizers, impact modifiers, acid copolymer wax, surfactants. Suitable fillers may also include inorganic fillers, such as zinc oxide, titanium dioxide, tin oxide, calcium oxide, magnesium oxide, barium sulfate, zinc sulfate, calcium carbonate, zinc carbonate, barium carbonate, mica, talc, clay, silica, lead silicate. Suitable fillers may also include high specific gravity metal powder fillers, such as tungsten powder and molybdenum powder. Suitable melt flow modifiers may include, for example, fatty acids and salts thereof, polyamides, polyesters, polyacrylates, polyurethanes, polyethers, polyureas, polyhydric alcohols, and combinations thereof.

In some embodiments, inner core 330 may have a high resilience. Such a high resilience may cause golf ball 300 to have increased carry and distance. The coefficient of restitution (COR) value of golf ball 300 is greater than the COR value of inner core 330 or the COR value of the entire core (inner core 330 surrounded by outer core 320). In some embodiments, inner core 110 has a COR of less than 0.8, depending on the initial velocity of the test. In some embodiments, inner core 330 may have a COR value ranging from 0.7 to less than 0.8, depending on the initial velocity of the test. Each layer of the ball has a COR. Inner core 330 has a first COR (i.e., conducting a COR test of just inner core 330), outer core 320 has a second COR (i.e., conducting a COR test of the entire core, inner core 330 surrounded by outer core 320), and cover layer 310 has a third or ball COR (i.e., conducting a COR test of the entire ball). The COR of the layers should also satisfy the following conditions for optimum feel: the third COR is greater than the first COR and the second COR. The difference between the third COR and the first COR is greater than 0.01. The difference between the third COR and the second COR is greater than 0.02.

In the first exemplary embodiment, inner core 330 has a first COR of about 0.7772 when measured with an initial velocity 131 ft/s, a second COR of about 0.7696 when measured with an initial velocity of 140 ft/s, and a third COR of about 0.7362 when measured with an initial velocity 160 ft/s. In the second exemplary embodiment, inner core 330 has a first COR of about 0.7854 when measured with an initial velocity 131 ft/s, a second COR of about 0.7763 when measured with an initial velocity of 140 ft/s, and a third COR of about 0.7462 when measured with an initial velocity 160 ft/s. These COR ranges are advantageous so that the overall COR value of golf ball 300 may be dampened by the outer layers to a desired level, such as less than 0.8. It is believed that such an inner core having a higher COR than 0.8 may have an undesirable feel.

Inner core 330 has a diameter between about 24 mm and 30 mm, and in the exemplary embodiment has a diameter of about 28 mm+/−0.3 mm. It is believed by the inventors that if the inner core diameter is less than about 24 mm, then the initial velocity off of the driver may be too low. It is also believed that if the inner core diameter is greater than about 30 mm, then more filler(s) may need to be added to any layer of the golf ball to maintain the proper weight distribution, which complicates the fabrication processes, and, therefore, may compromise consistent quality of batches or of different batches during production. A diameter of about 28 mm, in combination with the other layers of the exemplary embodiment, appears to balance driver initial velocity and feel, as will be discussed later.

The weight of inner core 330 in the first exemplary embodiment is about 11.23 g. The weight of inner core 330 in the second exemplary embodiment is about 11.22 g. Inner core 330 has a specific gravity of less than 1. In the first exemplary embodiment inner core 330 has a specific gravity of about 0.951. In the second exemplary embodiment, inner core 330 has a specific gravity of about 0.949. It is believed by the inventors that if the specific gravity of inner core 330 is higher than about 1, then the moment of inertia of the ball and the spin may be negatively impacted.

In the exemplary embodiment, inner core 330 has a compression deformation value of between about 4 mm and about 5 mm, when measured with an initial load of 10 kg and a final load of 130 kg. It is believed by the inventors that a compression deformation value of less than 4 mm when coupled with the other layers of the exemplary embodiments results in a ball with undesirable high pitched sound properties, an overly hard feel, and reduction of distance off the driver. It is also believed that a compression deformation value of greater than 5 mm results in a ball with too soft a feel, an undesirable amount of spin off of the mid-irons, and undesirable low pitched sound properties. In the first exemplary embodiment, the compression of inner core 330 is about 4.69 mm when measured with an initial load of 10 kg and a final load of 130 kg. In the second exemplary embodiment, the compression of inner core 330 is about 4.32 mm when measured with an initial load of 10 kg and a final load of 130 kg.

Inner core 330 may have a surface Shore D hardness from 40 to 50. In the first exemplary embodiment, inner core 330 has a surface Shore D hardness of about 44. In the second exemplary embodiment, inner core 330 has a surface Shore D hardness of about 47.

Inner core 330 may be made by any suitable process, but in the examples herein, inner core 330 is made by an injection molding process. During injection molding process, the temperature of the injection machine may be set within a range of about 190° C. to about 220° C. Generally, before the injection molding process, the highly neutralized polymer composition may be kept sealed in a moisture-resistant dryer capable of producing dry air. Drying conditions for the highly neutralized polymer composition may include 2 to 24 hours at a temperature below 50° C.

Outer core 320 generally surrounds and encloses inner core 330. Outer core 320 may be considered to be positioned radially outward of inner core 330. Outer core 320 in the exemplary embodiment comprises a thermoset rubber material. Outer core 320 in some embodiments has a thickness of between 4 mm and 8 mm. In both of the exemplary embodiments, the thickness of outer core 320 is about 5.5 mm. In the exemplary embodiment, where inner core 330 is made of a highly neutralized polymer composition having a diameter of about 28 mm, if the thickness of outer core 320 is less than about 4 mm, it is believed by the inventors that then more filler(s) may need to be added to any layer of the golf ball to maintain the proper weight distribution, which complicates the fabrication processes, and, therefore, may compromise consistent quality of batches or of different batches during production. It is believed by the inventors that the beneficial performance and aesthetic characteristics are maximized when the thickness of outer core 320 ranges from about 5.0 mm to about 6.0 mm. In some embodiments, the diameter of the entire core (inner core 330 and outer core 320 together) ranges from about 34 mm to about 40 mm. In the first exemplary embodiment, the diameter of the entire core is about 39.31 mm. In the second exemplary embodiment, the diameter of the entire core is about 39.28 mm.

Outer core 320 is generally formed by crosslinking a polybutadiene rubber composition as described in U.S. patent application Ser. No. 12/827,360, entitled Golf Balls Including Crosslinked Thermoplastic Polyurethane, filed on Jun. 30, 2010, and applied for by Chien-Hsin Chou et al., the disclosure of which is hereby incorporated by reference in its entirety. Various additives may be added to the base rubber to form a compound. The additives may include a cross-linking agent and a filler. In some embodiments, the cross-linking agent may be zinc diacrylate, magnesium acrylate, zinc methacrylate, or magnesium methacrylate. In some embodiments, zinc diacrylate may provide advantageous resilience properties. The filler may be used to alter the specific gravity of the material. The filler may include zinc oxide, barium sulfate, calcium carbonate, or magnesium carbonate. In some embodiments, zinc oxide may be selected for its advantageous properties. Metal powder, such as tungsten, may alternatively be used as a filler to achieve a desired specific gravity.

In some embodiments, a polybutadiene synthesized with a rare earth element catalyst may be used to form outer core 320. Such a polybutadiene may provide excellent resilience performance of golf ball 300. Examples of rare earth element catalysts include lanthanum series rare earth element compound, organoaluminum compound, and almoxane and halogen containing compounds. Polybutadiene obtained by using lanthanum rare earth-based catalysts usually employs a combination of a lanthanum rare earth (atomic number of 57 to 71) compound, such as a neodymium compound.

In some embodiments, a polybutadiene rubber composition having at least from about 0.5 parts by weight to about 5 parts by weight of a halogenated organosulfur compound may be used to form outer core 320. In some embodiments, the polybutadiene rubber composition may include at least from about 1 part by weight to about 4 parts by weight of a halogenated organosulfur compound. The halogenated organosulfur compound may be selected from the group consisting of pentachlorothiophenol; 2-chlorothiophenol; 3-chlorothiophenol; 4-chlorothiophenol; 2,3-chlorothiophenol; 2,4-chlorothiophenol; 3,4-chlorothiophenol; 3,5-chlorothiophenol; 2,3,4-chlorothiophenol; 3,4,5-chlorothiophenol; 2,3,4,5-tetrachlorothiophenol; 2,3,5,6-tetrachlorothiophenol; pentafluorothiophenol; 2-fluorothiophenol; 3-fluorothiophenol; 4-fluorothiophenol; 2,3-fluorothiophenol; 2,4-fluorothiophenol; 3,4-fluorothiophenol; 3,5-fluorothiophenol 2,3,4-fluorothiophenol; 3,4,5-fluorothiophenol; 2,3,4,5-tetrafluorothiophenol; 2,3,5,6-tetrafluorothiophenol; 4-chlorotetrafluorothiophenol; pentaiodothiophenol; 2-iodothiophenol; 3-iodothiophenol; 4-iodothiophenol; 2,3-iodothiophenol; 2,4-iodothiophenol; 3,4-iodothiophenol; 3,5-iodothiophenol; 2,3,4-iodothiophenol; 3,4,5-iodothiophenol; 2,3,4,5-tetraiodothiophenol; 2,3,5,6-tetraiodothiophenol; pentabromothiophenol; 2-bromothiophenol; 3-bromothiophenol 4-bromothiophenol; 2,3-bromothiophenol; 2,4-bromothiophenol; 3,4-bromothiophenol; 3,5-bromothiophenol; 2,3,4-bromothiophenol; 3,4,5-bromothiophenol; 2,3,4,5-tetrabromothiophenol; 2,3,5,6-tetrabromothiophenol; and their zinc salts, the metal salts thereof and mixtures thereof.

In the exemplary embodiment, outer core 320 is made from a composition of neodymium-catalyzed polybutadiene rubber (NdPBR) compounded with activated pentachlorothiophenol (PCTP).

In some embodiments, the specific gravity of outer core 320 may be from about 1 to about 1.45. In some embodiments, the specific gravity of outer core 320 may be from about 1.05 to about 1.35. In the first exemplary embodiment, the specific gravity of outer core 320 is about 1.277. In the second exemplary embodiment, the specific gravity of outer core 320 is about 1.274. In the exemplary embodiments, the difference between the specific gravity of outer core 320 and the specific gravity of inner core 330 is greater than about 0.2.

The weight of the entire core, outer core 320 and inner core 110 together, ranges from about 35 g to about 38 g. In the first exemplary embodiment, the weight of the entire core is about 36.97 g. In the second exemplary embodiment, the weight of the entire core is about 37.12 g.

Outer core 320 has a surface hardness, as measured on the curved surface of outer core 320, which is higher than the surface hardness of inner core 330. It is believed by the inventors that driver distance for lower club head speeds and feel are improved when outer core 320 has a higher hardness than inner core 330 when inner core 330 has a hardness that is less than 50 Shore D. Additionally, for golfers with lower club head speeds, such as less than about 90 mph, a harder outer core can make driver and iron shots have improved feel when inner core 330 has a hardness that is less than 50 Shore D. In some embodiments, outer core 320 may have a surface Shore D hardness of from about 45 to about 60. In the first exemplary embodiment, outer core 320 has a Shore D hardness of about 52 Shore D. In the second exemplary embodiment, outer core 320 has a Shore D hardness of about 49 Shore D.

In some embodiments, the entire core, i.e., outer core 320 enclosing inner core 330, has a compression between 3 mm and 4 mm, when measured with an initial load of 10 kg and a final load of 130 kg. It is believed by the inventors that a compression deformation value of less than 3 mm results in a ball that may lack durability, particularly with respect to delamination between inner core 330 and outer core 320 when inner core 330 is much softer than outer core 320, have an undesirably hard feel, have undesirable high pitched sound properties. It is also believed that a compression deformation value of greater than 4 mm may produce an undesirable amount of spin off of the mid-irons, short distance off the driver, and undesirable low pitched sound properties. In the first exemplary embodiment, the entire core has a compression of about 3.85 when measured with an initial load of 10 kg and a final load of 130 kg. In the second exemplary embodiment, the entire core has a compression of about 3.75 when measured with an initial load of 10 kg and a final load of 130 kg.

The entire core also has a coefficient of restitution, measured by firing the completed core (inner core 330 and outer core 320) from the testing cannon. In some embodiments, the COR of the entire core ranges from about 0.72 to less than about 0.78 based on different testing conditions. For example, the COR of the entire core of the first exemplary embodiment is about 0.772 when measured with an initial velocity of 131 ft/s, about 0.7558 when measured with an initial velocity of 140 ft/s, and about 0.7256 when measured with an initial velocity of 160 ft/s. The COR of the entire core of the second exemplary embodiment is about 0.7672 when measured with an initial velocity of 131 ft/s, about 0.7504 when measured with an initial velocity of 140 ft/s, and about 0.7234 when measured with an initial velocity of 160 ft/s.

Cover layer 310 substantially surrounds and encompasses outer core 320. Cover layer 310 may be considered to be positioned radially outward of outer core 320.

In some embodiments, cover layer 310 may be made from a thermoplastic material including at least one of an ionomer resin, a highly neutralized polymer composition, a polyamide resin, a polyester resin, and a polyurethane resin. In some embodiments, cover layer 310 is made from Surlyn®, and, in particular, a blend of different grades of Surlyn®. In some embodiments, two grades of ionomer are blended to make the material of cover layer 310. In the first exemplary embodiment, two grades of Surlyn® are blended to make the material of cover layer 310. At least a first grade of ionomer is a high flexural modulus ionomer (a flexural modulus greater than about 20,000 psi). In some embodiments, three grades of ionomer are blended to make the material of cover layer 310. In the second exemplary embodiment, cover layer 310 is made from a blend of three grades of Surlyn®. In the second exemplary embodiment, the first grade of Surlyn® and the second grade are each about 40% of the blend, while the third grade of Surlyn® is about 10% of the blend for cover layer 310. Similar to the first exemplary embodiment, at least a first grade of ionomer is a high flexural modulus ionomer. In some embodiments, the percentage in the cover material blend of the first grade of ionomer may range from about 30 to about 50, with 30%, 40%, and 50% being particularly advantageous percentages. In some embodiments, the percentage in the cover material blend of the second grade of Surlyn® may range from about 25 to about 50, with 25%, 30%, 35%, and 50% being particularly advantageous percentages. In some embodiments, the percentage in the cover material blend of the third grade of Surlyn®, a low flexural modulus ionomer (having a flexural modulus of less than about 8,000 psi) may range from zero (0) to about 35, with no third grade, 25%, 30%, and 35% being particularly advantageous percentages.

In some embodiments, cover layer 310 of golf ball 300 may have a Shore D hardness, as measured on the curved surface, ranging from about 60 to about 73. In some embodiments, the Shore D hardness of cover layer 310 is greater than about 65 and less than about 70. A cover hardness of less than about 70 Shore D maintains soft feel while chipping and putting. This hardness range yields beneficial feel, spinnability off of irons and wedges, and durability. In the first exemplary embodiment, cover layer 310 has a Shore D hardness of about 68. In the second exemplary embodiment, cover layer 310 has a Shore D hardness of about 69.

The relationship of the hardnesses of the layers of golf ball 300 to each other can also impact feel, durability, spin, and both driver and iron distance. Inner core 330 has a first surface hardness, outer core 320 has a second surface hardness, and cover layer 310 has a third surface hardness. In the first exemplary embodiment, the first surface hardness is about 44 Shore D, the second surface hardness is about 52 Shore D, and the third surface hardness is about 68 Shore D. In the second exemplary embodiment, the first surface hardness is about 47 Shore D, the second surface hardness is about 49 Shore D, and the third surface hardness is about 69 Shore D. In all embodiments, the third surface hardness is greater than the first surface hardness. In all embodiments, the first surface hardness is less than the second surface hardness. The absolute value of the difference between the first surface hardness and the second surface hardness is greater than about 1 and less than about 10. In the first exemplary embodiment, the absolute value of the difference between the first surface hardness and the second surface hardness is about 8 Shore D. In the second exemplary embodiment, the absolute value of the difference between the first surface hardness and the second surface hardness is about 2 Shore D. The absolute value of the difference between the third surface hardness and the second surface hardness is greater than about 15 and less than about 25 Shore D. In the first exemplary embodiment, the difference between the third surface hardness and the second surface hardness is about 16 Shore D. In the second exemplary embodiment, the absolute value of the difference between the third surface hardness and the second surface hardness is about 20 Shore D.

In some embodiments, cover layer 310 of golf ball 300 may have a thickness ranging from 1.2 mm to 2 mm for optimized durability and feel. In the first exemplary embodiment and second exemplary embodiment, cover layer 310 has a thickness of about 1.7 mm. In any embodiment, cover layer 310 may have a thickness selected to ensure that golf ball 300 is conforming. In the exemplary embodiments, golf ball 300 has an outer diameter of about 42.8 mm.

In some embodiments, golf ball 300 may have a moment of inertia between about 80 g/cm̂2 and about 90 g/cm̂2. In some embodiments, golf ball 300 may have a moment of inertia between about 83 g/cm̂2 and about 85 g/cm̂2. Such a moment of inertia may produce a desirable distance and trajectory, particularly when golf ball 300 is struck with a driver or driven against the wind.

In some embodiments, golf ball 300 may include a ball compression deformation of about 2.8 mm to about 4 mm when measured with an initial load of 10 kg and a final load of 130 kg. As is well known in the art, compression of a golf ball can influence driver distance and feel. In the first exemplary embodiment, the ball compression deformation is about 3.3 mm when measured with an initial load of 10 kg and a final load of 130 kg. In the second exemplary embodiment, the ball compression deformation is about 3.19 mm when measured with an initial load of 10 kg and a final load of 130 kg.

In the first exemplary embodiment, golf ball 300 has a weight of 45.38 g. In the second exemplary embodiment, golf ball 300 has a weight of 45.37 g.

Golf ball 300 as a whole also has a ball COR. The first exemplary embodiment has a COR of 0.7952 at an initial velocity of 131 ft/s, 0.782 at an initial velocity of 140 ft/s, and 0.751 at an initial velocity of 160 ft/s. The second exemplary embodiment has a COR of 0.7957 at an initial velocity of 131 ft/s, 0.7833 at an initial velocity of 140 ft/s, and 0.753 at an initial velocity of 160 ft/s. Golf ball 300 may be considered to have a first COR, the COR of inner core 330 measured with an initial velocity of 131 ft/s; a second COR, the COR of the entire core measured with an initial velocity of 131 ft/s; and a third COR or ball COR, the COR of the ball when measured with an initial velocity of 131 ft/s. The third COR is greater than the second COR and the first COR. The difference between the first COR and the second COR is greater than about 0.01. This design provides a beneficial driver ball speed while remaining a conforming ball. It is possible for the designer to optimize sound and feel off the driver while maintaining high initial velocity off the driver.

In some embodiments, golf ball 300 may have 300 to 400 dimples on the outer surface of cover layer 310. In some embodiments, golf ball 300 may have 310 to 360 dimples, which may have an improved trajectory over balls with higher or lower dimple counts. In the exemplary embodiment, golf ball 300 has 314 dimples.

Table 1 shows structure and static data for golf balls prepared according to exemplary embodiments, which include Design 1 and Design 2.

TABLE 1
Structure and Static Data of Exemplary Embodiments

| Ball, Part of | | | | |
|---|---|---|---|---|
| Ball | Diameter (mm) | Weight (g) | Shore D Hardness | SG (g/cc) |
| Design 1, | 28.18 | 11.23 | 44 | 0.951 |
| Inner Core | | | | |
| Design 2, | 28.2 | 11.22 | 47 | 0.949 |
| Inner Core | | | | |
| Design 1, | 39.31 | 36.97 | 52 | 1.277 |
| Outer Core | | | | |
| Design 2, | 39.28 | 37.12 | 49 | 1.274 |
| Outer Core | | | | |
| Design 1, | 42.78 | 45.38 | 68 | 0.961 |
| Entire Ball | | | | |
| Design 2, | 42.8 | 45.37 | 69 | 0.965 |
| Entire Ball | | | | |

Table 2 shows compression and COR data for Design 1 and Design 2.

TABLE 2
Compression and COR Measurements of Exemplary Embodiments

| Ball, Part of | Compression, | | | |
|---|---|---|---|---|
| Ball | 10-130 Kg (mm) | COR131 | COR140 | COR160 |
| Design 1, | 4.69 | 0.7772 | 0.7696 | 0.7362 |
| Inner Core | | | | |
| Design 2, | 4.32 | 0.7854 | 0.7763 | 0.7462 |
| Inner Core | | | | |
| Design 1, | 3.85 | 0.772 | 0.7558 | 0.7256 |
| Outer Core | | | | |
| Design 2, | 3.75 | 0.7672 | 0.7504 | 0.7234 |
| Outer Core | | | | |
| Design 1, | 3.3 | 0.7952 | 0.782 | 0.7510 |
| Entire Ball | | | | |
| Design 2, | 3.19 | 0.7957 | 0.7833 | 0.7530 |
| Entire Ball | | | | |

Next, a general discussion will be provided of how golf balls having an inner core and an outer core are made. Golf balls that include cores formed by multiple pieces, such as first inner core 330 and first outer core 320 of golf ball 300 and second inner core 440 and second outer core 430 of golf ball 400, may be formed by a multi-step process. For example, first outer core 320 and second outer core 430 may be first formed as separately molded sections that are subsequently molded about first inner core 330 and second inner core 440, respectively, to form first outer core 320 about first inner core 330 and to form second outer core 430 about second inner core 440. When made of thermoset materials, such as butadiene rubber (BR), such molded sections may be produced in the form of hemispherical sections or cups which are configured to encase a previously molded inner core when the hemispherical sections are molded about the inner core, causing to the hemispherical sections to join together to form the outer core. Subsequently, the molded combination of outer core and inner core may be further processed to manufacture a golf ball, such as, for example, by grinding off any molding flash, tumbling the outer core/inner core combination to roughen its outer surface, and to apply further materials, such as the materials for a mantle and/or a cover.

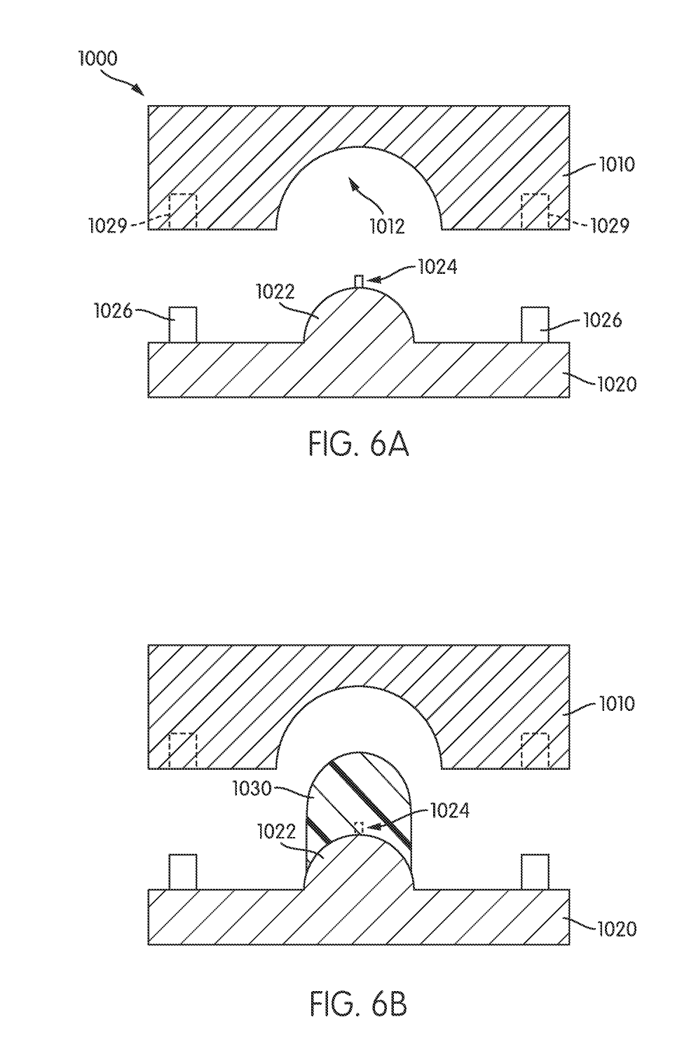

FIG. 5A depicts a side sectional view of a conventional mold 500 for producing a hemispherical section of an outer core. Such a hemispherical section may be matched with a corresponding hemispherical section. The two hemispherical sections may be subsequently molded together to produce an outer core, such as outer core 320 of golf ball 300 or outer core 430 of golf ball 400, for example. Another part or parts may be positioned between the hemispherical portions as well prior to being molded together. Mold 500 may include an upper mold plate 510 and a lower mold plate 520 for compression molding a material. Lower mold plate 520 may include a projection 522 while upper mold plate 510 may include a cavity 512 that is sized and shaped to receive projection 522. Projection 522 has a shape corresponding to an inner surface of a hemispherical section where an inner core would be located. In such embodiments, projection 522 may be provided as a rounded projection. Cavity 512 has a shape corresponding to an outer surface of the hemispherical section. Lower mold plate 520 may include lugs 526 or other devices that provide a gap between upper mold plate 510 and lower mold plate 520 when mold 500 is closed. As will be recognized by those of ordinary skill in the art, lugs 526 may instead be located on upper mold plate 510 or on both upper mold plate 510 and lower mold plate 520.

As shown in the example of FIG. 5B, a slug 530 is placed within mold 500, between projection 522 and cavity 512, which may serve as a material to be molded. Slug 530 may be a material suitable for molding a hemispherical section subsequently used to mold an outer core, such as a thermoset material or any of the other materials discussed above. Slug 530 may have a shape suitable for use in mold 500, such as a dome shape, cylindrical shape, or other suitable shape. A surface of slug 530 facing projection 522 may be concave with a shape corresponding to projection 522, as shown in FIG. 5B. In another example, the surface of slug 530 facing projection 522 may be flat, or may have other shapes used in the art. The surface of slug 530 facing projection 522 may be shaped to assist with positioning slug 530 on projection 522. For example, the surface of slug 530 facing projection 522 may have a concave shape, as shown in FIG. 5B.

To assist in maintaining the position of the slug 530 within mold 500, projection 522 may include a mechanical fastening device 524 to attach slug 530 to projection 522 to a degree. For instance, mechanical fastening device 524 may be a pin that penetrates the material of slug 530, as shown in FIG. 5B, although other fastening devices may be used. The length of mechanical fastening device 524 may be from 0.5 mm to 5 mm, or from 0.5 mm to 3 mm.

Once slug 530 has been placed within mold 500, mold 500 is closed so that upper mold plate 510 and lower mold plate 520 are brought together, as shown in FIG. 5C. Upper mold plate 510 and lower mold plate 520 may move along guide rods, be hinged, or actuated by other devices (not shown) enabling at least one of upper mold plate 510 and lower mold plate 520 to move relative to the other to close mold 500. Closing mold 500 and pressing upper mold plate 510 against lower mold plate 520 with a pressure ranging between about 85 kg/cm² and about 170 kg/cm² causes slug 530 to be deformed between upper mold plate 510 and lower mold plate 520, particularly on the outer surface of projection 522 and within cavity 512, although slug 530 may bulge outward to a degree within a gap provided between upper mold plate 510 and lower mold plate 520. According to an embodiment, at least one of upper mold plate 510 and lower mold plate 520 may be heated to assist with curing of slug 530.

According to an embodiment, a mold may include one or more alignment pins and one or more holes corresponding to the alignment pins. The alignment pins may assist with alignment of mold plates during a molding process. Such alignment pins may be provided in a mold instead of lugs 526. Turning to FIG. 14A, an example of a mold 1000 for producing a hemispherical section of an outer core is shown. Mold 1000 may include an upper mold plate 1010 and a lower mold plate 1020 for compression molding a material. Lower mold plate 1020 may include a projection 1022 while upper mold plate 1010 may include a cavity 1012 that is sized and shaped to receive projection 1022. Lower mold plate 1020 may include one or more alignment pins 1026 or other devices that mate with upper mold plate 1010 to assist with alignment between upper mold plate 1010 and lower mold plate 1020. For example, upper mold plate 1010 may include one or more alignment holes 1029 that correspond to the one or more alignment pins 1026 of lower mold plate 1020. Such alignment pins 1026 and alignment holes 1029 may assist in providing projection 1022 and cavity 1012 in a concentric or coaxial alignment when mold 1000 is closed. As will be recognized by those of ordinary skill in the art, alignment pins 1026 may instead be located on upper mold plate 1010 and alignment holes 1029 may be provided on lower mold plate 1020, or alignment pins 1026 and alignment holes 1029 may be provided on both upper mold plate 1010 and lower mold plate 1020.

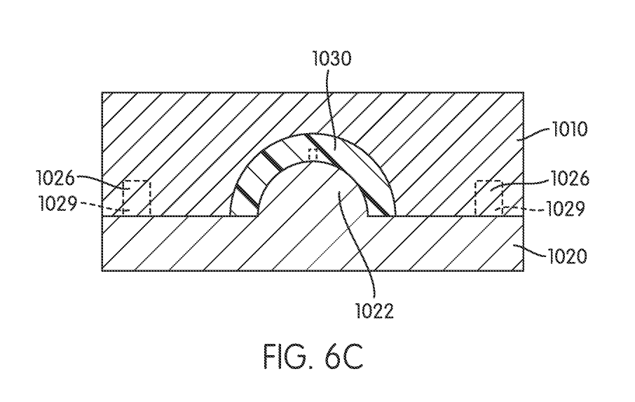

As shown in the example of FIG. 6B, a slug 1030 is placed within mold 1000, between projection 1022 and cavity 1012, which may serve as a material to be molded. Once slug 1030 has been placed within mold 1000, mold 1000 is closed, as discussed above in regard to mold 500 in FIG. 5C, so that upper mold plate 1010 and lower mold plate 1020 are brought together, as shown in FIG. 6C.

Due to the shape of the surfaces of cavity 512 and projection 522 of mold 500 in FIG. 5C, slug 530 is deformed into a particular shape, such as a hemispherical section 632. Similarly, the shape of cavity 1012 and projection 1022 of mold 1000 in FIG. 6C may deform slug 1030 into a particular shape, such as a hemispherical section 632. Such a hemispherical section 632 may have a cup-like shape. Hemispherical section 632 may, for example, form substantially half of an outer core, such as first outer core 320 and second outer core 430, above, that is subsequently molded from two hemispherical sections 632.

A second hemispherical section 632 is molded and, as shown in FIG. 5D, hemispherical sections 632 are arranged to encase a previously molded inner core 640. Hemispherical sections 632 and inner core 640 are then placed between an upper mold 710 and a lower mold 712, as shown in FIG. 5E, with inner core 640 placed between hemispherical sections 632. Upper mold 710 and lower mold 712 are subsequently pressed together to join hemispherical sections 632 to form a completed core, which has an outer core that encases inner core 640, such as outer core 320 of golf ball 300 shown in FIG. 3 or outer core 430 of golf ball 400 shown in FIG. 4. The resulting core combination may then be processed in the manner discussed above to produce a golf ball.

Other configurations and examples may be employed to form a completed core. For example, a completed core according to the present disclosure may be formed by the process described in U.S. Patent Publication Number 2013/0140734, which is hereby incorporated by reference in its entirety. Similarly, a completed core according to the present disclosure may be formed by the process described in U.S. patent Publication Ser. No. ______, currently U.S. Ser. No. 13/456,930, titled “Mold Plate And Method Of Molding Golf Ball Core”, and filed Apr. 26, 2012, in the name of Chin-Shun Ko et al., which is hereby incorporated by reference in its entirety

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method of manufacturing a golf ball, comprising:
blending a highly neutralized acid polymer with a first ionomer to form a resin blend, the highly neutralized acid polymer having a first flexural modulus of less than 8,000 psi, and the first ionomer having a second flexural modulus of less than 8,000 psi;
injection molding the resin blend to form an inner core of the golf ball;
compression molding a thermoset material around the inner core to form an outer core surrounding the inner core; and
injection molding a cover layer around the outer core.

2. The method according to claim 1, wherein the highly neutralized acid polymer has a first Vicat softening temperature and the first ionomer has a second Vicat softening temperature, the absolute value of difference between the first Vicat softening temperature and the second Vicat softening temperature is not greater than 10 degrees Celsius.

3. The method according to claim 1, wherein the inner core has a compression deformation value of between about 4 mm and about 5 mm, when measured with an initial load of 10 kg and a final load of 130 kg.

4. The method according to claim 1, wherein the inner core has a first surface hardness, the outer core has a second surface hardness, and the cover layer has a third surface hardness, the absolute value of the difference between the first surface hardness and the second surface hardness being greater than about 1 and less than about 10.

5. The method according to claim 1, wherein the first ionomer includes from about 1 to about 20 parts by weight of the inner core, based on 100 parts by weight of the inner core.

6. The method according to claim 1, wherein the inner core further comprises a second ionomer having a third flexural modulus.

7. The method according to claim 6, wherein the sum of the first flexural modulus and the second flexural modulus is less than the third flexural modulus.

8. The method according to claim 6, wherein the second ionomer is between 0 and 25 parts by weight of inner core, based on 100 parts by weight of the inner core.

9. The method according to claim 8, wherein the inner core has a diameter of about 24 mm to about 30 mm.

10. The method according to claim 9, wherein the outer core has a thickness of about 4 mm to about 12 mm.

11. The method according to claim 10, wherein the cover layer has a thickness of about 1 mm to about 4 mm.

12. The method according to claim 1, wherein the inner core has a coefficient of restitution measured at 131 ft/s of less than 0.8.

13. A method of making a golf ball, comprising:
blending a highly neutralized acid polymer with a first ionomer to form a resin blend, the highly neutralized acid polymer having a first flexural modulus of less than 8,000 psi, and the first ionomer having a second flexural modulus of less than 8,000 psi and the first ionomer including from about 1 to about 20 parts by weight of the inner core, based on 100 parts by weight of the inner core;
injection molding the resin blend to form an inner core of the golf ball;
providing a first mold plate including a first mold surface;
providing a second mold plate including a second mold surface corresponding to the first mold surface;
positioning a material between the first mold surface and the second mold surface; and
moving at least one of the first mold plate and the second mold plate towards the other of the first mold plate and the second mold plate thereby compressing the material into a first hemispherical cup.

14. The method of claim 13, wherein the first mold surface comprises a flat surface and the second mold surface comprises a rounded projection.

15. The method of claim 13, further comprising:
forming second hemispherical cup; and
compression molding the first hemispherical cup and the second hemispherical cup around the inner core to form an outer core surrounding the inner core.

16. The method of claim 13, wherein the material is a thermoset.

17. A method of manufacturing a golf ball, comprising:
blending a highly neutralized acid polymer with a first ionomer and a second ionomer to form a resin blend, the highly neutralized acid polymer has a first Vicat softening temperature and the first ionomer has a second Vicat softening temperature and the absolute value of difference between the first Vicat softening temperature and the second Vicat softening temperature is not greater than 10 degrees Celsius;
injection molding the resin blend to form an inner core of the golf ball;
compression molding a thermoset material around the inner core to form an outer core surrounding the inner core; and
injection molding a cover layer around the outer core.

18. The method according to claim 17, wherein the inner core has a first surface hardness, the outer core has a second surface hardness, and the cover layer has a third surface hardness, the absolute value of the difference between the first surface hardness and the second surface hardness being greater than about 1 and less than about 10.

19. The method according to claim 17, wherein the inner core has a diameter of about 24 mm to about 30 mm, the outer core has a thickness of about 4 mm to about 8 mm, and the cover layer has a thickness of about 1.2 mm to about 2 mm.

20. The method according to claim 17, further comprising:
providing a first mold plate including a first mold surface;
providing a second mold plate including a second mold surface corresponding to the first mold surface;
positioning a material between the first mold surface and the second mold surface; and
moving at least one of the first mold plate and the second mold plate towards the other of the first mold plate and the second mold plate thereby compressing the material into a first hemispherical cup.
